(19) United States
(12) Patent Application Publication
(10) Pub. No.: US 2022/0185195 A1
(43) Pub. Date: Jun. 16, 2022

(54) VEHICULAR FLOWER HANGER

(71) Applicant: Alexander Knipper, Upland, CA (US)

(72) Inventor: Alexander Knipper, Upland, CA (US)

(21) Appl. No.: 17/247,555

(22) Filed: Dec. 16, 2020

(51) Int. Cl. B60R 7/08; B60R 7/04; A01G 5/04

(52) U.S. Cl. CPC B60R 7/085; A01G 5/04; B60R 7/043

(57) ABSTRACT

A vehicular flower hanger is provided. The vehicular flower hander has an open collar for circumscribing a portion of one or more flowers in such a way as to pin or balance the flowers against the rear surface of a vehicle seat. The open portion of the open collar may facilitate placement of the flowers in the open collar as well as the open collar conforming to the rear surface. The open collar provides two spaced apart pivot points, from each pivot point extend a hanger element, each hanger element is adapted to be removably connected to the headrest of the seat. The pivotable connections further facilitates supporting the flowers against the rear seat through enabling the open collar to conform thereto.

### BACKGROUND OF THE INVENTION

The present invention relates to flower holders; and, more particularly, a vehicular flower hanger having an open collar providing two spaced apart pivot points, and wherein a hanger element extends from each pivot point so as to hang flowers in an upright position within the open collar from the headrest of a seat of the vehicle.

Bouquets of flowers are used in home or building décor around the world. However, while this mode of aesthetically enhancing the interior has had no purchase in the automotive space. This likely reflect the fact that flowers tend to be kept in soil retained by a vessel. The vessel takes up space in the confined environment of a vehicle's cabin and can be easily broken when the vehicle is in motion. Also, while the vehicle is moving, the soil can easily spill, making a mess that is hard to avoid.

As can be seen, there is a need for a vehicular flower hanger that requires no soil or vessel, and is specially adapted to hang from the headrest of the vehicle's seat, all while providing a compact, aesthetically-pleasing, low profile design.

### SUMMARY OF THE INVENTION

In one aspect of the present invention, a vehicular flower hanger includes the following: only one open collar; only two pivot points on opposing portions of said open collar; and a hanger element pivotably connected to each pivot point, wherein each hanger element provides a detachable fastener at a distal end thereof, wherein an open portion along a perimeter of the open collar is between an eighth of an inch to a half of said perimeter in length, wherein the open collar is circular, rectangular or other shapes that enable the disclosure described herein.

In another aspect of the present invention, method of retaining one or more flowers against a rear surface of a vehicle seat wherein the one or more flowers is not in soil and not in a vessel, the method includes the following: sliding the one or more flowers through an open portion of an open collar, wherein the open collar has two opposing pivot points; hanging two hanging elements from a headrest of said vehicle seat, each hanging element pivotably connected to one of the two opposing pivot points; and facing the open portion against said rear surface so that the open collar pivots about the two opposing pivot points in such a way that a portion of the one or more flowers is supported while another portion of the one or more flowers is supported by said rear surface.

These and other features, aspects and advantages of the present invention will become better understood with reference to the following drawings, description and claims

### BRIEF DESCRIPTION OF THE DRAWINGS

FIG. 1 is a perspective view of an exemplary embodiment of the present invention;

FIG. 2 is a top plan view of an exemplary embodiment of the present invention;

FIG. 3 is a side elevation view of an exemplary embodiment of the present invention; and

FIG. 4 is a perspective view of an exemplary embodiment of the present invention, shown in use.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a vehicular flower hanger provides an open collar for circumscribing a portion of one or more flowers in such a way as to pin or balance the flowers against the rear surface of a vehicle seat. The open portion of the open collar may facilitate placement of the flowers in the open collar as well as the open collar conforming to the rear surface. The open collar provides two spaced apart pivot points, from each pivot point extend a hanger element, each hanger element is adapted to be removably connected to the headrest of the seat. The pivotable connections further facilitates supporting the flowers against the rear seat through enabling the open collar to conform thereto.

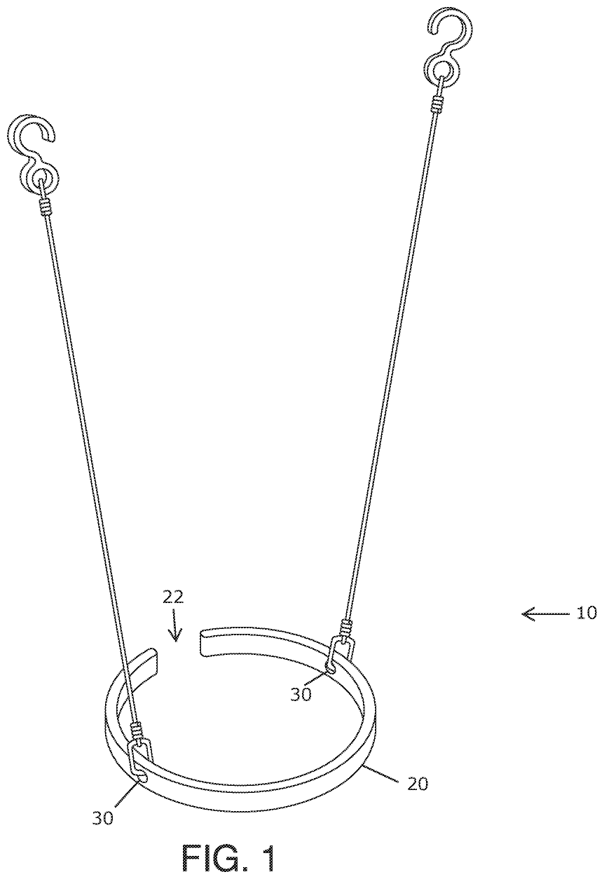

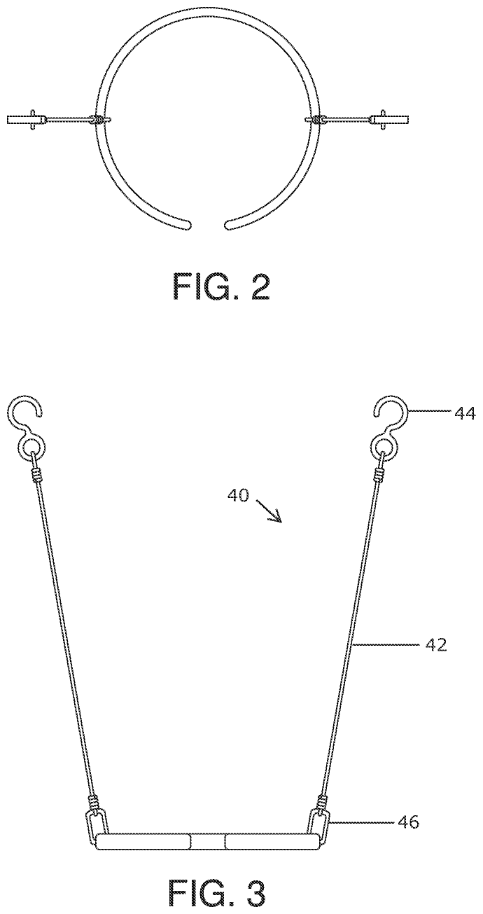

Referring now to FIGS. 1 through 4, the present invention may include a vehicular flower hanger 10 having an open collar 20 providing two spaced apart pivot points 30, wherein a hanging element 40 is pivotably connected to each pivot point 30 in such a way that the open collar 20 can be hung from a headrest of a seat of the vehicle, whereby the open collar 20 and the bouquet of flowers 50 therein conforms to the rear of said seat.

The open collar 20 may be any shape, not just the arcuate shape shown in the attached Figures, as long as the open collar 20 provides an ‘open’ portion 22 of the open collar 20. Likewise, the open collar 20 may be any size as long as it functions in accordance with the disclosure provided herein. Similarly, the open portion 22 may be any percentage of the length of the open collar 20, as long as it is, in certain embodiments, at least greater than an eighth of an inch. Thus, the open portion 22 could extend between the pivot points 30, or in other words, the length and position of the open portion 22 may be different depending on the embodiment.

The pivot points 30 are typically on opposing sides of the open collar 20 to facilitate predictable pivoting of the open collar 20 relative to the hanging elements 40 that extend therefrom. For instance, in one embodiment, where the open collar 20 is circular, the pivot points 30 would be diametrically opposed to each other.

The hanging elements 40 may be any sufficiently elongated flexible material 42, such as string, cord, or the like, each having a detachable fastener 44 at its distal end. The detachable fastener 44 may be a hook or the like. The proximal end has a pivotable connector 46, such as a loop or the like, that enables the proximal end to pivot or rotate about the pivot point 30 to which it attaches. The pivotable connector 46 may be a rigid loop, while the pivot point 30 is a through-hole in the open collar 20.

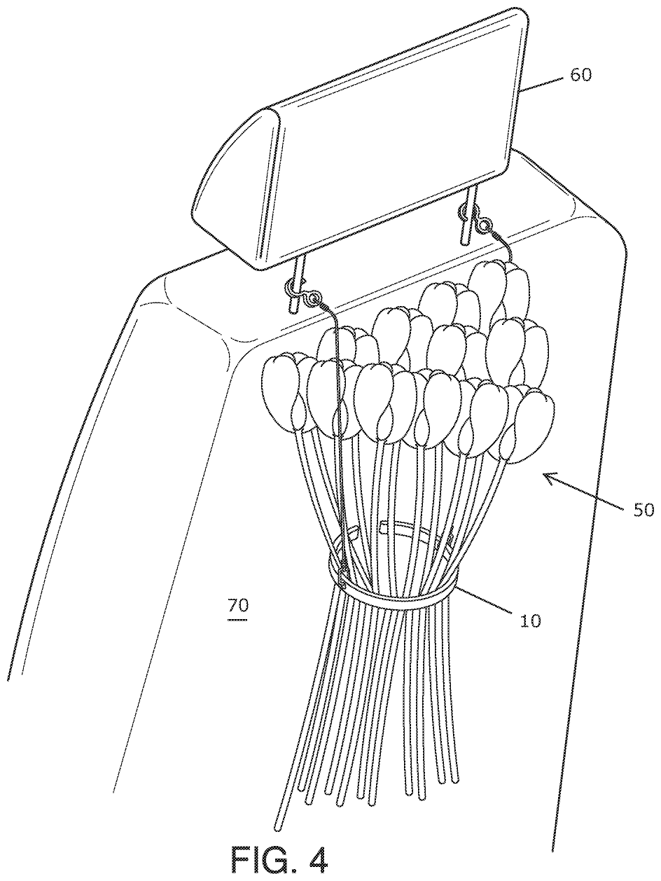

A method of using the present invention may include the following. The vehicular flower hanger 10 disclosed above may be provided. One or more flowers 50 may be inserted in the open collar 20 after the detachable fasteners 44 of the hanging elements 40 are connected to the headrest 60 of the automobile. The open collar 20 pivots about the pivot points 30 (relative to the handing elements 40 supported by the headrest 60) until it conforms to a rear surface 70 of the seat associated with the headrest 60, as illustrated in FIG. 4, so that the open collar 20 pins a portion of the flowers 50 against said rear surface 70. Other applications may include suspending or hanging cargo items such as clothing items, masks, handbags and the like, in certain embodiments, from the open portion 22 or over the open collar 20.

It should be understood, of course, that the foregoing relates to exemplary embodiments of the invention and that modifications may be made without departing from the spirit and scope of the invention as set forth in the following claims.

What is claimed is:

1. A vehicular flower hanger comprising:
only one open collar;
only two pivot points on opposing portions of said open collar; and
a hanger element pivotably connected to each pivot point.

2. The vehicular flower hanger of claim 1, wherein each hanger element provides a detachable fastener at a distal end thereof.

3. The vehicular flower hanger of claim 2, wherein an open portion along a perimeter of the open collar, the open portion extending up to a half of said perimeter in length.

4. The vehicular flower hanger of claim 3, wherein the open collar is circular.

5. The vehicular flower hanger of claim 3, wherein the open collar is rectangular.

6. A method of retaining one or more flowers against a rear surface of a vehicle seat wherein the one or more flowers is not in soil and not in a vessel, the method comprising:
sliding the one or more flowers through an open portion of an open collar, wherein the open collar has two opposing pivot points;
hanging two hanging elements from a headrest of said vehicle seat, each hanging element pivotably connected to one of the two opposing pivot points; and
facing the open portion against said rear surface so that the open collar pivots about the two opposing pivot points in such a way that a portion of the one or more flowers is supported while another portion of the one or more flowers is supported by said rear surface.
